(19) United States
(12) Patent Application Publication
(10) Pub. No.: US 2007/0067186 A1
(43) Pub. Date: Mar. 22, 2007

(54) Method and system for electronically prescribing medications

(76) Inventors: Ira Brenner, Bethesda, MD (US); Scott Puritz, Chevy Chase, MD (US)

Correspondence Address: MCGUIREWOODS, LLP, 1750 TYSONS BLVD, SUITE 1800, MCLEAN, VA, 22102, US

(21) Appl. No.: 11/525,124

(22) Filed: Sep. 22, 2006

Related U.S. Application Data
(60) Provisional application No. 60/719,183, filed on Sep. 22, 2005.

(51) Int. Cl. G06Q 10/00; H04M 1/00

(52) U.S. Cl. 705/2; 455/556.2

(57) ABSTRACT

Methods, systems and devices for electronically prescribing medication to a patient include providing to a prescriber prescription medications in response to a request to prescribe medication to a patient, allowing selection of one of the prescription medications, in response to the selection of one of the prescription medications, determining in a processor whether alternative prescription medications having equal or more preferred status than the selected prescription medication exist based upon the patient's health plan, and if any such alternative medication exists, alerting the prescriber of the preference status of the selected prescription medication and alternative prescription medication.

### CROSS-REFERENCE TO RELATED APPLICATIONS

This application claims priority under 35 U.S.C. §119(e) to provisional U.S. Patent Application 60/719,183 filed on Sep. 22, 2005, the disclosure of which is expressly incorporated by reference herein in its entirety.

### BACKGROUND OF THE INVENTION

1. Field of the Invention

The invention is directed generally to an electronic prescription method and system and, more particularly, to a method and system for displaying prescription medication information to a prescriber and alerting the prescriber as to the existence of alternative prescription medication information based upon the most preferred status of the medication in the patient's insurance plan. The prescriber then can choose an alternative prescription based upon the most preferred status of the medication and write the prescription electronically. As used herein, the most preferred status may be indicative of the formulary status, adjudicated (“true patient”) costs, co-pay or other characteristics of the medication. The invention also is directed to a method and device that automates the prescription process such that it reduces costs and creates a revenue source for a third party that implements the invention as described. Furthermore, the invention may allow for provision of electronic prescribing devices at no-cost or below cost to promote acceptance and obtain revenue from use of the device from other entities.

2. Related Art

Despite the prevalence of personal computers and electronics since at least the late '80s and numerous attempts at electronic prescription systems in at least the past decade, approximately 99% of all prescription medication scripts written by a prescriber today, such as a physician, are processed via paper. The paper prescription system costs the medical industry billions of dollars every year. In particular, handwritten scripts cause costs related to processing telephone calls regarding prescriptions, non-compliance of prescription medications not being filled, the filling of wrong prescriptions, which may lead to adverse prescription medication reactions that hospitalize or cause deaths of patients to name a few.

As noted above, the shortcomings of the paper process have led to many attempts in the last decade to replace the paper prescription process with an electronic process. However, these previous electronic approaches have not been accepted in the market place for several reasons. First, the cost of the electronic systems and devices that run them has created a barrier to entry and kept the prescriber from electronic prescribing. In this case, the prescriber must pay to install the device, pay to maintain it, and/or pay to rent the system. Secondly, prescribers have not embraced such electronic devices because of the complexity of using the device compared with writing scripts. For example, in the previous generation of electronic prescribing systems, formulary information was presented before the physician had selected a clinically appropriate drug. This approach has proven ineffective because the information is presented too early in the prescribing process to be useful to the physician. Also, the display of formulary status of all drugs leaves small PDA screens cluttered with icons and often unreadable. Additionally, some approaches failed because of lack of speed. A prescriber is unlikely to use an electronic prescription device when the prescriber is able to prescribe a medication quicker with paper script writing.

An important factor in prescribing medication is costs. The prescriber that writes the prescription may not always write a prescription for a medication that will have the lowest cost to the patient. In other words, a doctor can often write prescriptions for numerous equivalent medications, only a few of which are preferred by the patient's healthcare plan. The healthcare plan prefers and will pay a greater portion of the cost for certain prescription drugs and not provide a cost savings to other prescription drugs.

Accordingly, the foregoing demonstrates that there is a longstanding need for an electronic prescription system that avoids the costs, drawbacks and disadvantages of the paper script process while allowing a prescriber to electronically initiate prescriptions quickly with a very simple and intuitive electronic device and write prescriptions with little, if any, entry costs. In particular, there is a need for a method and device that will guide a physician in choosing the most preferred prescription drug for a patient and their associated healthcare plan. Moreover, there are also needs for improved record keeping for all parties involved in the scripting process, including the prescriber, patient and fulfillment center, as well as needs for ensuring that a patient actually obtains the prescription medication, also referred herein as compliance.

### SUMMARY OF THE INVENTION

The invention meets the foregoing needs and avoids the costs, disadvantages, and drawbacks of the traditional paper script process by providing a method and system that quickly and efficiently automates the prescription process, alerts and allows the prescriber to choose an alternative preferred prescription, which may be based upon cost. Thus, the invention can reduce the costs of treating patients and reduce the costs to the medical, insurance and/or pharmaceutical industries, thereby achieving cost savings without affecting the standard of care for the patient. The invention may also provide for the ability to print multi-part forms together having prescription information, including the legal prescription for the patient, a prescriber's record (chart) copy, and optionally an informational message for the patient.

The data generated by electronic prescription process also may be used to determine what current prescription medications a patient is taking and provides an automated alerting mechanism for the prescriber to avoid adverse medication reactions. Moreover, the data generated during electronic prescribing has further commercial value that may be used to subsidize the costs of installing and operating the system.

The invention may be implemented in a number of ways:

According to one aspect of the invention, an electronic medical prescription device for prescribing medication to a patient includes a display having a first screen configured to list prescription medications in response to a request to prescribe medication to a patient, an input that allows selection of one of the prescription medications on the display, and a processor configured to determine and display, in response to the selection of one of the prescription medications, a second screen showing the selected prescription medication, together with alternative prescription medications having equal or more preferred status than the selected prescription medication, if any exist, as determined by the patient's health plan.

The processor may be further configured to determine and display on the second screen a relative ranking factor indicative of the preference status of the displayed selected prescription medication and the alternative prescription medications, if any exist. The relative ranking factor may include a graphical representation indicative of at least one of a co-pay tier, approximate co-pay, adjudicated cost, formulary status, and health plan preference. The first screen may display prescription medications without showing any indication of formulary status and the second screen lists prescription medications showing an indication of formulary status. The second screen may display the prescription medications along with an indication of their formulary status to automatically alert the user as to the formulary status of the displayed medications. The display of formulary status on the second screen may be generated automatically with each displayed medication and is not user selectable. The second screen may display all alternative prescription medications that have a more preferred status than the displayed selected prescription medication, if any, as determined by the patient's health plan. The processor may be further configured to determine and display on the second screen the dosage of the displayed selected prescription medication and the equivalent mapped dosage of the alternative prescription medications. The second screen may be further configured to allow selection of one of the selected alternative prescription medications in order to prescribe to a patient. The processor may display a cart screen in response to selection of one of the selected or alternative prescription medications. The cart screen may include at least one of the names of the medication, the dosage, the preference status, the SIG, and refill information for the selected medication prior to ordering the medication. The device further may include a checkout screen configured to allow ordering of the selected medication by selection of a specific drug fulfillment entity to electronically send the prescription or print the prescription on paper. The cart screen may allow a user to add further prescriptions prior to ordering the selected medication via the checkout screen. The processor may select the alternative prescription medications based on a determination of the existence of at least one of generic equivalents of the selected prescription medication, more preferred status than the selected prescription medication, and class alternatives to the selected prescription medication. The device further may include a printer to print a multiple-part form including a legal prescription and a chart copy attached to the prescription by a frangible connection. The printer may be further configured to print a consumer-oriented message on the form. The multiple-part form may include two frangible connections to create a three-portion form, with the chart copy being on the first portion of the form, the legal prescription being on the second portion of the form, and the consumer message being on the third portion of the form. The frangible connection may be created by the printer by partially cutting the paper such that the prescription and the chart copy are initially attached with an uncut portion of the paper. The processor may be configured to display a patient selection screen showing a list of patients on the display based on information from at least one of a patient database, an Electronic Medical Records (EMR) database, or a physician's office management information system (POMIS) database. The processor may be further configured to display a prescription drug history based on at least one of the patient database, the Electronic Medical Records (EMR) database, the physician's office management information system (POMIS) database, or health plan records, in response to selecting one of the patients on the patient selection screen. The processor may determine whether any alternative prescription medication exists by querying a database having information specific to the patients' health plan formulary. The processor may be configured to display a cart screen including characteristic information for the selected prescription medication only, if no alternative prescription medication having equal or more preferred status exists.

According to another aspect of the invention, a method of electronically prescribing medication to a patient includes the steps of providing to a prescriber prescription medications in response to a request to prescribe medication to a patient, allowing selection of one of the prescription medications, in response to the selection of one of the prescription medications, determining in a processor whether alternative prescription medications having equal or more preferred status than the selected prescription medication exist based upon the patient's health plan, and if any such alternative medication exists, alerting the prescriber of the preferred status of the selected prescription medication and alternative prescription medication.

The determining step may include querying a database including the formulary status of available prescription medications and, if no alternative medications exist having equal or more preferred status, further comprising the step of providing to the prescriber information characteristics of the selected prescription medication. The providing step may provide a listing of prescription medications without any indication of formulary status. The alerting step may be automated and not user selectable. The formulary status may be only provided as part of the alerting step. The determining step may determine whether any alternative prescription medication having a more preferred status than the selected prescription medication exists. The alerting step may further include the step of alerting the prescriber of the equivalent mapped dosage of any alternative prescription medication having an equal or more preferred status than the selected prescription medication based upon the patient's health plan formulary. The equivalent mapped dosage alerting step may include alerting the prescriber as to the equivalent mapped dosages of all alternative prescription medications having equal or preferred formulary status than the selected prescription medication. The method further may include allowing selection of one of the selected or alternative prescription medications. The method further may include the step of displaying a checkout screen to allow selection of a specific drug fulfillment entity to electronically send the prescription or print the prescription on paper. In the method, fulfillment cost information of the selected medication may be displayed on the checkout screen. The method further may include, in response to selecting one of the prescription medications, determining in the processor whether there exists at least one of generic equivalents to the selected prescription medication, more preferred status than the selected prescription medication, and class alternatives to the selected prescription medication. The method further may include the step of providing a list of patients based on at least one of a patient database, an Electronic Medical Records (EMR) database, or a physician's office management information system (POMIS) database. The method further may include the step of obtaining a prescription drug history based on information from at least one of the patient database, the Electronic Medical Records (EMR) database, the physician's office management information system (POMIS) database, or health plan records in response to selecting one patient in the list of patients.

According to yet another aspect of the invention, a computer readable medium executable on a computer for prescribing medication with an electronic device having a display executes the steps of listing prescription medications on an electronic display in response to a request to prescribe medication to a patient, allowing selection of one of the prescription medications on the display, in response to the selection of one of the prescription medications, determining in a processor whether alternative prescription medications having equal or more preferred status than the selected prescription medication exist based upon the patient's health plan, and if any such alternative medication exists, alerting the prescriber of the preferred status of the selected prescription medication and alternative prescription medications. All of the above noted method steps may be implemented by the computer readable medium.

According to a further aspect of the invention, a device for electronically alerting a prescriber as to the existence of low cost alternatives to a prescription drug during electronic prescribing includes means for providing prescription medications in response to a request to prescribe medication to a specific patient, means for allowing selection of one of the prescription medications, and means for determining and alerting a prescriber, in response to the selection of one of the prescription medications, the selected prescription medication, together with alternative prescription medications having equal or more preferred status than the selected prescription medication, if any exist, as determined by the patient's health plan. The device further may include means for providing a relative ranking factor indicative of the preference status of the selected prescription medication and the alternative prescription medications, if any exist.

According to yet another aspect of the invention, a computer system for electronically alerting a prescriber as to the existence of lower cost alternatives to a prescription drug during electronic prescribing includes: an electronic data center in communication with at least one drug information database selected from the group consisting of a pharmacy, drug, drug reference, and drug equivalence database; a source of patient-specific health plan information, including at least one of medication history and pharmacy benefit plan information, and an electronic prescription fulfillment entity in communication with at least one drug fulfillment service; and a point of care computer system including a controller and at least one of a database containing patient-specific information and an electronic prescribing device. The controller may be in electronic communication with and managing connectivity between the electronic prescribing device and the electronic data center to upload information from the patient-specific health plan information source to the electronic prescribing device, to upload information from the at least one drug information database to the electronic prescribing device, and to download prescription information from the electronic prescribing device to the electronic prescription fulfillment entity. The electronic prescribing device may be responsive to selection of a prescription drug for a patient to display cost information related to alternative drugs having a more preferred status based upon the patient's health plan, if any exist, thereby alerting the prescriber to the existence of lower cost alternative drugs than the selected prescription drug. The source of health plan information may include an aggregator of prescription benefit information, and the electronic prescription fulfillment entity may be in communication with at least one of retail and mail order pharmacies. The controller may permit at least some of the transmissions between the data center and the electronic prescribing device to occur in real time.

According to yet a further aspect of the invention, a method of transmitting medical prescriptions with an electronic device includes the steps of delivering data associated with medical prescriptions to or from at least one of a retail pharmacy, a medical facility, a health insurance entity, pharmacy benefit manager (PBM), and an electronic prescription fulfillment entity, monitoring the delivery of data, and obtaining revenue from at least one of the retail pharmacy, the medical facility, the health insurance entity, the pharmacy benefit manager (PBM), and the electronic prescription fulfillment entity, wherein the revenue may be based on one of a per transaction basis, contingent outcome basis, and a service basis. The data may include at least one of the initial prescription medication selected by the prescriber, a listing of lower cost alternatives, or the selection of one of the lower cost alternatives. The method may include the step of at least one of delivering, setting-up, and maintaining the electronic device at one of no cost or below cost to a prescriber.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention, are incorporated in and constitute a part of this specification, illustrate embodiments of the invention and together with the detailed description serve to explain the principles of the invention. No attempt is made to show structural details of the invention in more detail than may be necessary for a fundamental understanding of the invention and the various ways in which it may be practiced. In the drawings:

FIG. 1 is a schematic diagram showing a global architecture of an implementation of an electronic prescription system constructed according to the principles of the invention;

FIG. 2 is a detailed portion of the schematic diagram of FIG. 1 showing an implementation of an in-office architecture of a physician's office or other medical facility constructed according to the principles of the invention where electronic scripts may be written;

FIG. 3 is a schematic diagram showing the interaction of an electronic prescribing device of the invention with systems in the global architecture of the invention shown in FIG. 1;

FIGS. 4 and 5 are flow diagrams showing exemplary logic of the invention for operation of the architecture shown in FIG. 3;

FIG. 6 is a detailed portion of a part of the flow diagram of FIG. 4 showing exemplary logic for carrying out the low cost alerting mechanism of the invention;

FIG. 7 shows an exemplary embodiment of a portable, hand-held electronic prescribing device constructed according to the principles of the invention;

FIG. 8 shows a personal computer embodiment of an electronic prescribing device constructed according to the principles of the invention;

FIG. 9 shows an enlarged view of an exemplary patient selection screen of the electronic prescribing device of FIG. 7;

FIG. 10 shows an exemplary drug display menu for the electronic prescribing device of FIG. 7 from which a prescriber may select a medication to prescribe;

FIGS. 11 and 12 show a drug display menu for alerting the prescriber of the most preferred status of the selected and alternative medications;

FIG. 13 shows an exemplary checkout screen for the selected drug as displayed on electronic prescribing device of FIG. 7;

FIG. 14 shows an exemplary drug interaction alert screen for the electronic prescribing device of FIG. 7;

FIGS. 15 and 16 show exemplary paper scripts and attached records that may be printed out with the electronic system of the invention;

FIGS. 17 and 18 show examples of how the low cost alerting mechanism of the invention may operate;

FIG. 19 is a diagram showing the various entities that receive benefits and/or cost savings from use of the electronic prescribing method and system of the invention; and

FIG. 20 is a diagram showing a revenue model implemented according the principles of the invention.

### DETAILED DESCRIPTION OF THE INVENTION

The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals represent similar parts throughout the several views of the drawings.

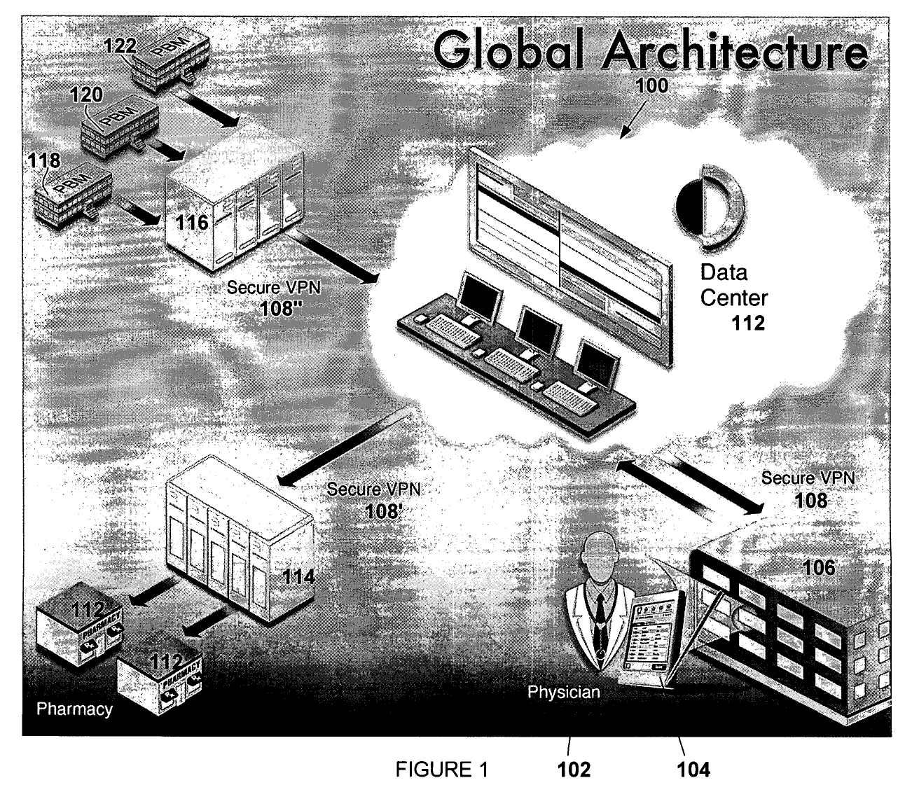

FIG. 1 schematically shows an exemplary global architecture 100 for an electronic prescription system constructed according to the principles of the invention. In particular, a prescriber 102, such as a physician, treats patients at the point of care in a medical office 106. In the course of caring for the patient, the prescriber 102 may prescribe the patient a prescription medication that must be distributed or filled from a pharmacy 112. The prescriber 102 uses an electronic prescribing device 104 of the invention tailored to display and operate based on the specific patient's information, such as formulary status, to review the patient's drug history and prescribe medications electronically. The information may include the currently prescribed prescription medication information obtained from a health information entity 116 such as aggregator of prescription benefit information like RxHub™, which collects this information from pharmacy benefit managers (PBMs) 118, 120, 122 and/or from health insurance entities, such as any entity that pays for all or part of a patient's health care services including but not limited to health insurance company, employer, HMOs, PPOs, self-funded health plans, federal and state health plans, TPAs, unions, and the like hereinafter collectively referred to as a “health plan.” The health information entity 116 transmits the requisite prescription information to a data center 112 over a secure network, such as a virtual private network (VPN) 108. The data center 112 and VPN 108 may form part of the system of the invention as noted below.

The health information entity 116 electronically routes up-to-date patient information, which may include medication history and pharmacy benefit plan information to prescribers 102. The health information entity 116 delivers electronic prescribing with a nationwide information exchange connecting prescribers 102, patients, pharmacies 112, fulfillment entity 114 and PBMs 118, 120, 122 for the conveyance of relevant medication and plan information at the point of care. As noted above the health information entity 116 may aggregate all of the pharmacy benefit information from the plurality of PBMs 118, 120, 122. The PBMs 118, 120, 122 may represent the patients' health plan.

Next the prescriber 102 may prescribe the prescription medication to the patient while using the electronic prescription device 104, as described in more detail below. Once the prescriber 102 has prescribed the prescription medication to the patient using the electronic prescription device 104, the device 104 may automatically transmit the prescription information over the VPN 108 to the data center 112. The data center 112 acts as an intermediate party to the transmission of the prescription medication information from the prescriber 102 via the electronic prescription device 104 to both a pharmacy 112 and the health plan, which is typically represented by a PBM 118, 120, 122. In particular, when the prescriber 102, using the electronic prescription device 104, prescribes the prescription medication, the request for the prescription medication is sent over the VPN 108 to the data center 112. The data center 112 then forwards the prescription medication request from the prescriber 102 to an electronic fulfillment entity 114 such as SureScripts™, which may include an electronic prescribing network to link electronic communications between a pharmacy 112 and a prescriber 102, allowing the electronic exchange of prescription information over a secure network, such as a VPN 108′. The electronic fulfillment entity 114 then forwards the prescription medication request to the patient's desired pharmacy 112.

Thus, the data center 112 of the invention receives current prescription medication information from the health information entity 116, e.g., via the PBMs 118, 120, 122, over a secure network, such as a VPN 108″, which aggregates information from the health insurance entity and allows the information to be displayed on the electronic prescribing device 104. The data center 112 also receives requests for the filing of a prescription medication from the prescriber 102 in a medical office 106 and forwards the prescription to be filled at the pharmacy 112 through the electronic fulfillment entity 114.

It should be noted that the VPNs 108, 108′, 108″ shown in FIG. 1 connecting the data center 112 and the medical office 106; the data center 112 and the fulfillment entity 114; and the data center 112 and the health information entity 116, respectively, may not be and very likely are not the same network, but may be different networks in communication with each other. Moreover, each of the exemplary VPNs shown in FIG. 1 may not necessarily be VPNs but may be any type of secure network including secure socket layer (SSL) and the like. In particular, the use of VPN 108 enables all the communications between medical office 106 and data center 112 to be encrypted. The networks 108′ and 108″ may use transaction specific encryptions, such as SSL, instead of a VPN.

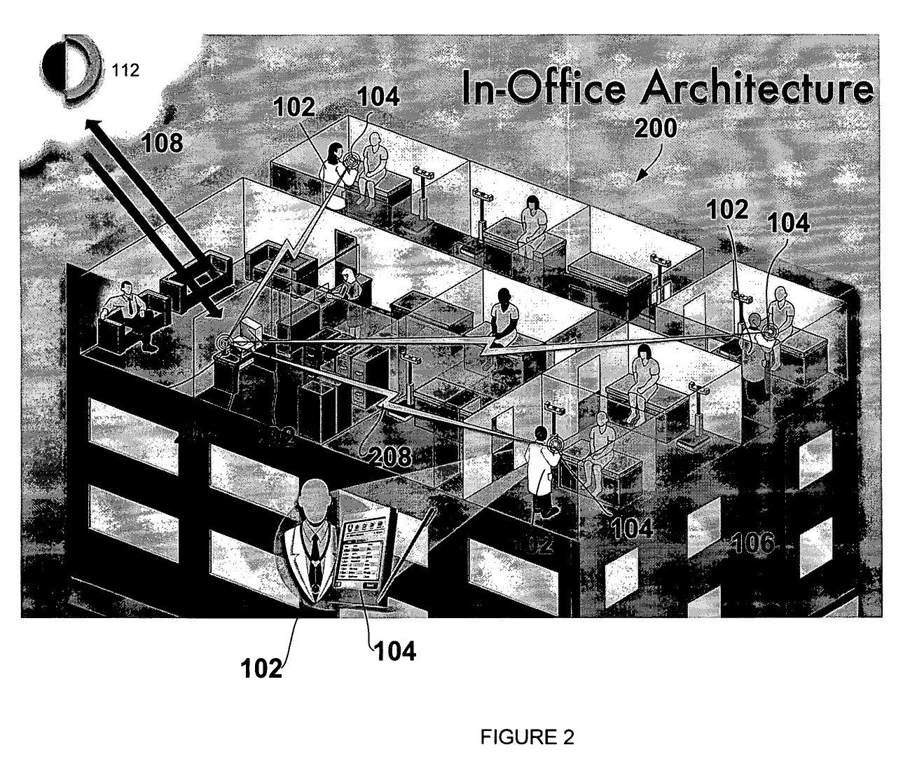

FIG. 2 schematically shows a typical implementation of the in-office architecture 200 of the invention in a medical facility 106. As shown in FIG. 2, the medical facility 106 includes an electronic prescription system of the invention that enables one or more prescribers 102 in the medical facility 106 to use a plurality of electronic prescribing devices 104 of the invention to treat patients at the point of care in their medical facility 106. More specifically, each of the prescribers 102 are able to treat a patient by obtaining patient information, including prescription medication history and insurance information and prescribe one or more prescription medications to the patients using their respective electronic prescribing devices 104.

In this regard, a prescriber 102, after determining a course of treatment for a patient, may enter a prescription request in the electronic prescribing device 104. The electronic prescribing device 104 may be connected to a wireless local area network (WLAN) 208. The WLAN 208 may include a transceiver 206 and the prescription medication request may be received in the transceiver 206. The transceiver 206 may then route the data to a centralized device such as a computer 202. The centralized computer 202 can then either print the prescription medication request script on a printer 204, as requested by the prescriber 102, and/or transmit the request for the prescription medication to the VPNs 108, 108′, 108″ for electronic prescription filling as described previously. Alternatively, the transceiver 206 may operate stand-alone to transmit the prescription medication request. Additionally, the WLAN 208 may provide patient data to the electronic prescribing device 104 including currently prescribed prescription medications. Moreover, it is contemplated that the WLAN 208 may provide additional data transactions that are apparent to those in the art, such as updates on the latest medicines or as further described herein.

The WLAN 208 may employ a Wireless Fidelity (Wi-Fi) type network compliant with IEEE 802.11, 802.11(a), 802.11(b), 802.11(g), 802.11(n), 802.16, and 802.20, or may be a wireless network including Bluetooth™, ultra wideband (UWB), WCDMA (wideband code-division multiple access), WiMAX or any other known technology using a licensed or unlicensed frequency. Moreover, any future enhancement of a current protocol or any future wireless protocol may be employed for use with the invention.

It should be noted that the in-office architecture 200 may take a plurality of different forms. In particular, the electronic prescribing devices 104 may be implemented as pocket PC's, personal digital assistants (PDA), personal computers (PC), computer tablets, laptops or any other electronic device capable of receiving input and sending requests and other electronic transmissions over VPNs 108, 108′, 108″ or similar networks. The devices 104 may be associated with individual prescribers or separate treatment rooms.

Moreover, the in-office architecture shown in FIG. 2 includes a WLAN 208, however, any type of wired or wireless network may be employed as would be known to one of ordinary skill. Additionally, the centralized computer 202 may also employ various electronic medical record (EMR) functions, data, and programs as is well known in the art; may employ a physician's office management information system (POMIS) with associated functions, data, and programs as is well known in the art; and/or a controller providing gateway and/or server functions as is well known in the art.

Additionally, the centralized computer 202 may also employ an electronic prescribing controller constructed according to the principles of the invention. The controller may be dedicated to a practice or to an office/building complex, where multiple co-located but independent practices utilize the invention. The controller may function as a system that manages network connectivity between the practice(s) and the data center 112, provides real-time monitoring of data regarding application uptime and application performance, enforces the network security policy of the system and may serve as a local data cache for the application in order to drive better application performance and enhance application reliability in the case where connection to the data center 112 is temporarily unavailable.

Additionally, it should be noted that although a centralized computer 202 and a WLAN 208 are shown in the medical office 106, the electronic prescribing devices 104 could just as easily connect in a wireless manner to a larger wireless network such as a cellular type network, wireless broadband, or a Wi-MAX type of network or the like that includes transceivers located outside the medical office 106.

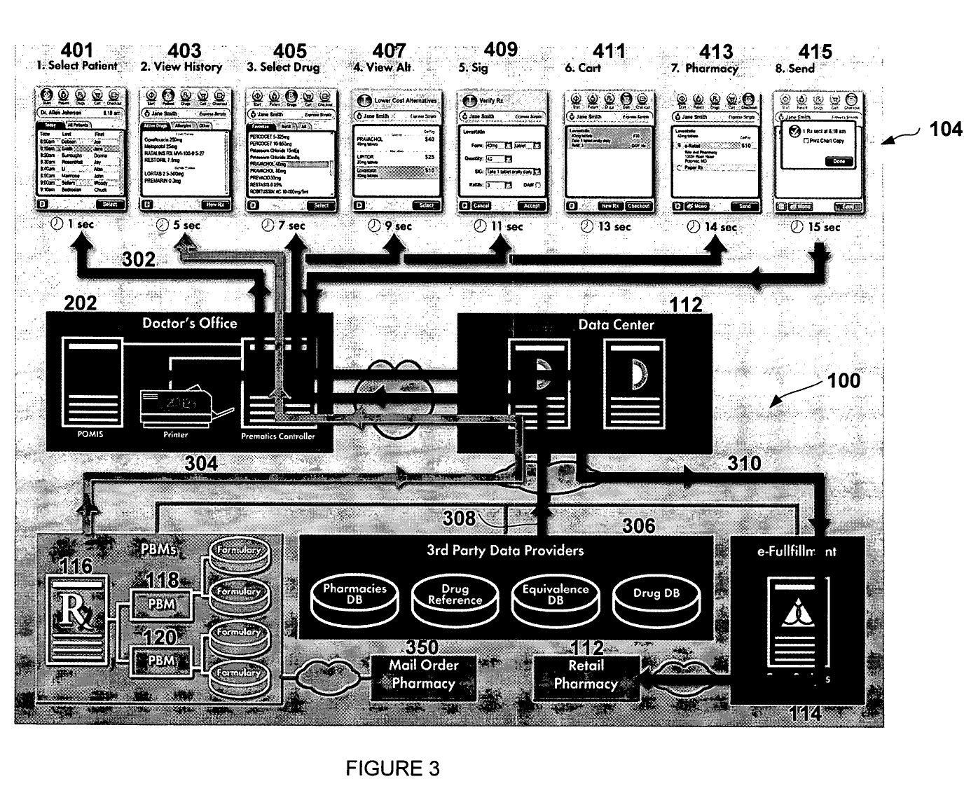

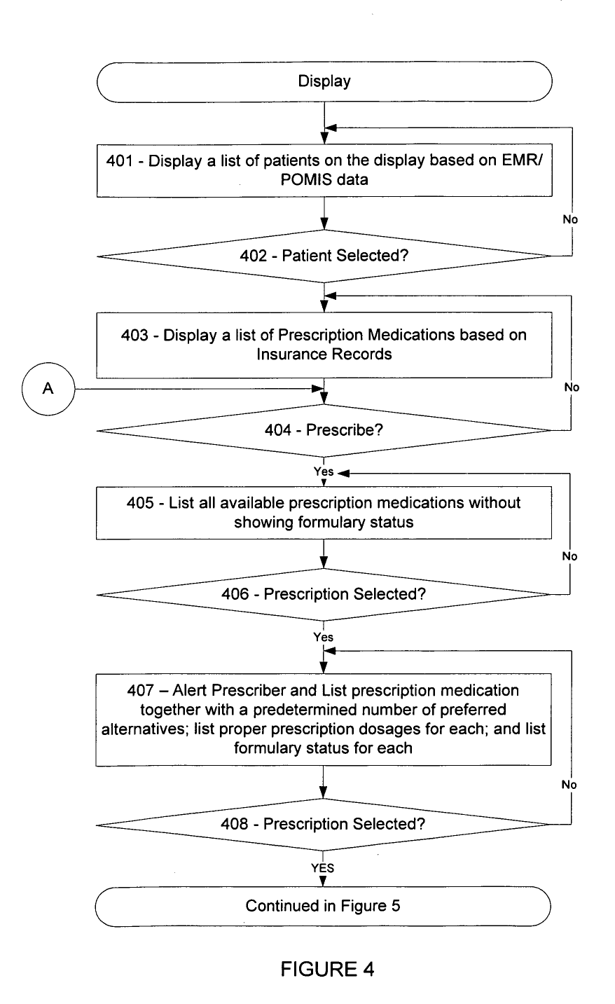

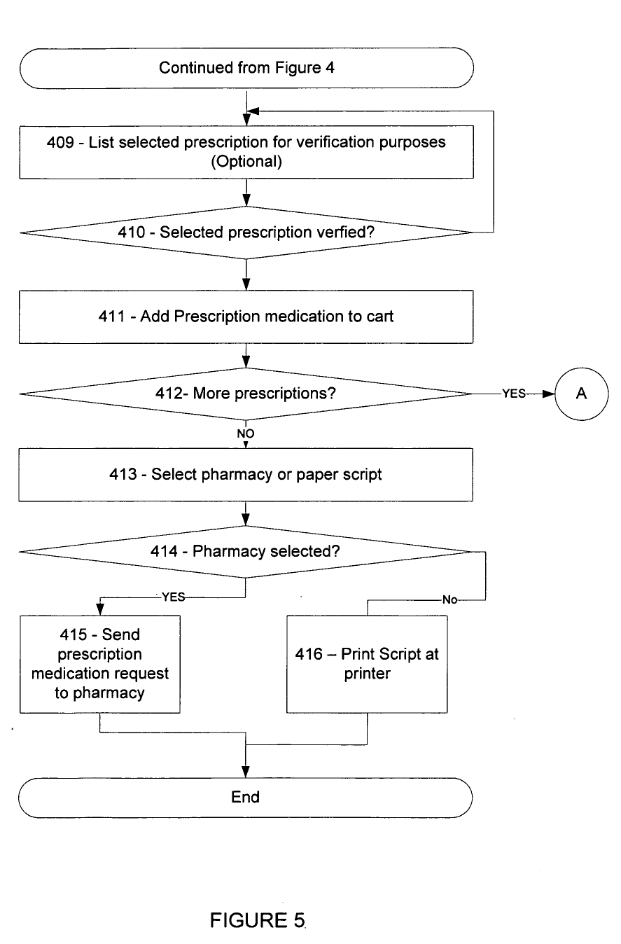

FIG. 3 schematically shows the interaction of the electronic prescribing device 104 of the invention with the systems in a global architecture 100 of the invention, which together may operate according to the exemplary logic shown in FIGS. 4 and 5. In this regard, the following discussion may be most helpful when viewing these figures together. When a patient schedules an appointment with the doctor's office or other medical facility, their appointment may be added to the doctor's office POMIS or EMR system. The POMIS or EMR system may then from time to time connect over the VPN 108″ to the data center 112 and provide this appointment information thereto. The data center 112 may then request information regarding the patient to the health information entity 116 and the PBMs 118, 120, 122. In response thereto the PBMs 118, 120, 122 may send prescription medication information together with health plan information to the health information entity 116 that may transmit the same over the VPN 108 to the data center 112 over the VPN 108 to the doctor's office to be provided to either the POMIS, EMR, or the controller that is part of the architecture of the invention. This information may be obtained several days, hours or minutes prior to the patient's scheduled appointment or may be transmitted to the doctor's office in real time as needed. Finally, the information that is in the POMIS or controller may then be transferred to the electronic prescribing device 104 for use by the prescriber 102.

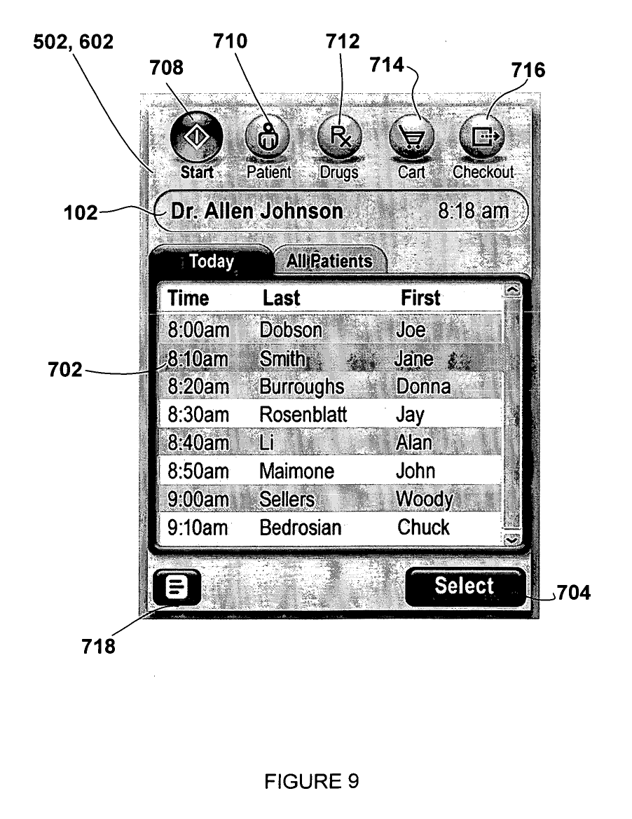

When a prescriber 102 is at the point of care treating a patient, the prescriber 102 may use the electronic prescribing device 104 to select a patient from a list displayed in the electronic prescribing device 104 as shown in step 401. In particular, the electronic prescribing device 104 may list all of a particular prescriber's 102 patients based on any criteria including chronological appointment time, name in alphabetical order, or any other contemplated order, in a display of the electronic prescribing device 104. An exemplary listing is shown in FIG. 9 discussed below. The list of patients may be retrieved by the electronic prescribing device 104 periodically through the WLAN 208 from the medical facility centralized computer 202 and in particular the office medical information system such as the EMR and/or POMIS as shown by transmission 302 and as described above. Accordingly, the prescriber 102 may choose the patient from the displayed list of patients of the electronic prescribing device 104 with an input device such as a mouse, stylus, keyboard, microphone with voice responsive software or the like as is known in the art in step 402.

In step 403, the electronic prescribing device 104 retrieves the patient's drug history, including at least the prescription medication currently prescribed to the selected patient. In particular, in step 403, the electronic prescribing device 104 may display all of the prescribed prescription medications for the selected patient from any prescriber 102, which may include prescriptions written by prescribers (such as specialists, podiatrists or dentists) not associated with the office 106 but which are known to the PBMs 118, 120, 122, and hence the data center 112. The electronic prescribing device 104 may receive from the centralized computer system 202 all of the prescription medications that have been prescribed to the patient and which have been provided by the health information entity 116 via one of more of the PBM's 118, 120 (122 not shown) as shown by transmission 304 in FIG. 3. Even though a prescription medication may have been prescribed in a different doctor's office, if the prescription benefit has been paid by the health plan via entity 116, this information is listed in the health information entity's 116 database and may be transmitted to the centralized computer system 202 and to the electronic prescribing device 104 for display thereof at step 403.

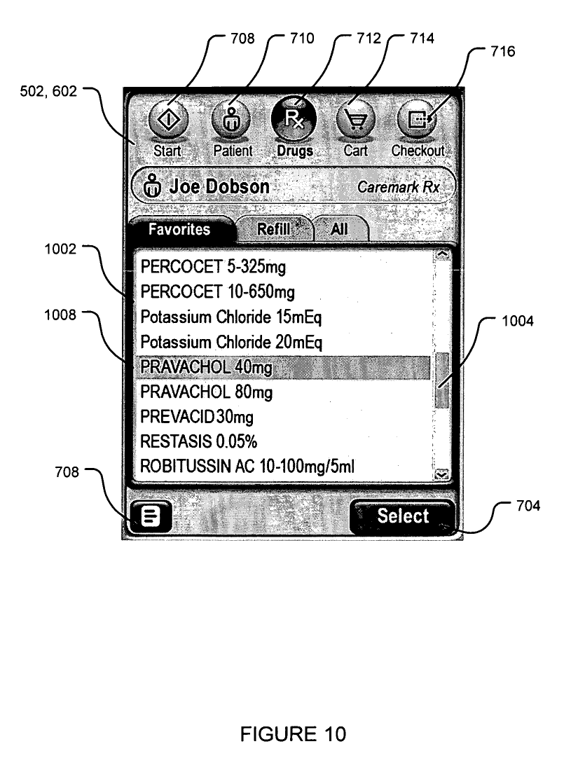

After the prescriber 102 has examined the patient and determined a course of treatment requiring the prescribing of at least one prescription medication, the prescriber 102 may then choose to prescribe prescription medication as shown in step 404 in FIG. 4. In this regard, prescription medications are listed, in for example an alphabetical list of such prescription medicines as shown in step 405 shown in FIGS. 3 and 4. FIG. 10 shows an exemplary listing of medications under the prescriber's list of favorite drugs. The listing of prescription medications may be based on information in a third party collection of databases 306, which may include at least one of a pharmacies database, prescription medication database, reference database, an equivalence database, and a prescription medication database but does not include any information related to or reflecting formulary status. The data forming the listing of prescription medications is shown by transmission 308. The transmission 308 may be processed through the data center 112 and the centralized computer 202 before being listed in the display of the electronic prescribing device 104.

Next, the prescriber 102 uses an input device such a mouse, keyboard, stylus, microphone with voice responsive software, or the like to choose a desired prescription medication from the listing for the treatment of the patient as shown in step 406 of FIG. 4. As noted above, no formulary status information is shown at this step because it is not useful at this stage of the process and may clutter the screen of device 104.

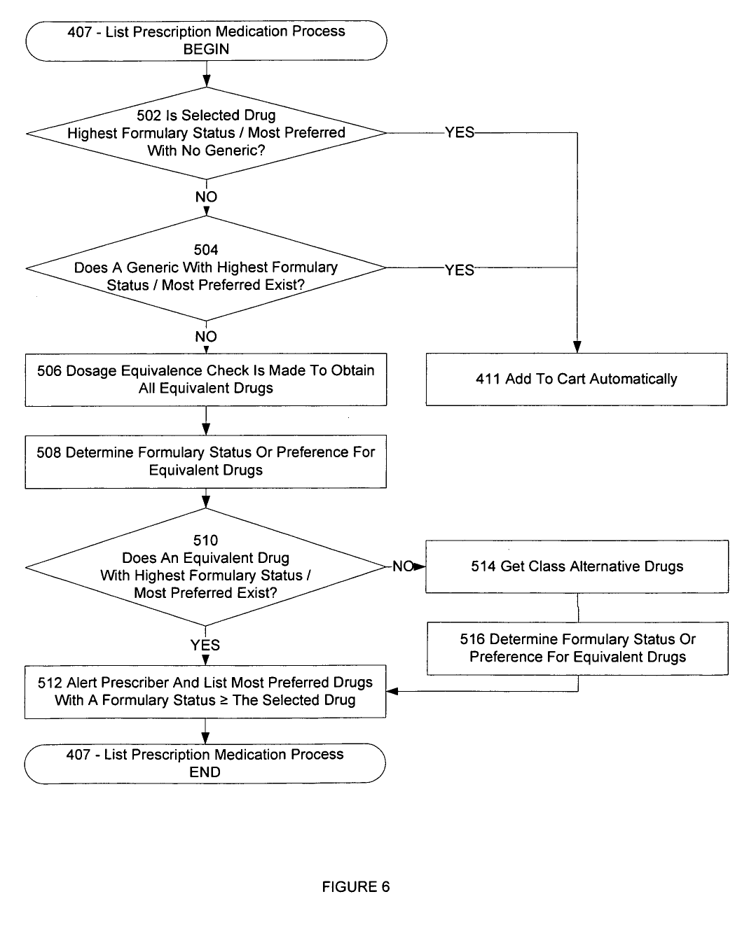

In step 407, the prescriber 102 is alerted and the selected prescription medication is listed on the display device of the electronic prescribing device 104, along with a predetermined number of more preferred alternative prescription medications, if they exist, which are obtained from the patient's health plan formulary. Hence, the patient's formulary determines the preferred status of any prescription medication. An icon such as $ signs, the co-pay amount, the true cost, the co-pay tier, or other rating (hereinafter collectively “preference status”) for each of these alternative prescription medications and the selected prescription medication may be displayed on the lower cost alternatives (“LCA”) Screen. As shown in FIG. 3, the LCA Screen in this example shows the co-pay amount of the selected medication (PRAVACHOL) and the more preferred alternatives. In addition, the alternatives are displayed in dosage mapped equivalents. Thus, the third party data provider 306 provides equivalent prescription medications and maps the dosages of the equivalent prescription medications to generate equivalents to the selected prescription medication for use in step 407. The health information entity 116 via PBMs 118, 120, 122 may also provide, based on the formulary of the health plan, a list of possible preferred alternative prescription medications and their respective preference status. Together the third party data provider 306 and health information entity 116 provide data via the data center 112 and the office centralized computer 202 that may alert the prescriber by listing various prescription medication alternatives on the electronic prescribing device 104. The data being generated may be based on an algorithm such as that described below in conjunction with FIG. 6.

In a particular aspect of the invention, the equivalence dosage mapping may be performed, when possible, between the drug selected by the prescriber 102 and more preferred alternatives. Also, based on the algorithm, only the most preferred prescription medication alternatives, if any exist, are displayed in step 407 in response to selecting a prescription medication. The display of only the most preferred alternative prescription medications, even though there may often be many more alternative prescription medications, helps drive physician behavior toward prescribing lower cost medication, and limits confusion and clutter on the display screen. The alternative prescription medication is clinically equivalent to what has been prescribed and available at a lower cost for the patient. All things being equal in these two respects, the decision may be based on other third party revenue arrangements regarding specific drug alternatives. However, the primary criteria selection process for this limitation is cost to the patient and hence the use of preference status. Additionally, through the use of the button 718 (FIG. 9) the prescriber 102 may view all lower cost alternatives including those that were initially displayed. This optional “second step” makes accessing lower cost alternative prescription medications a slightly slower and more cumbersome process, but may be desirable as it makes available to the prescriber 102 all clinically relevant information.

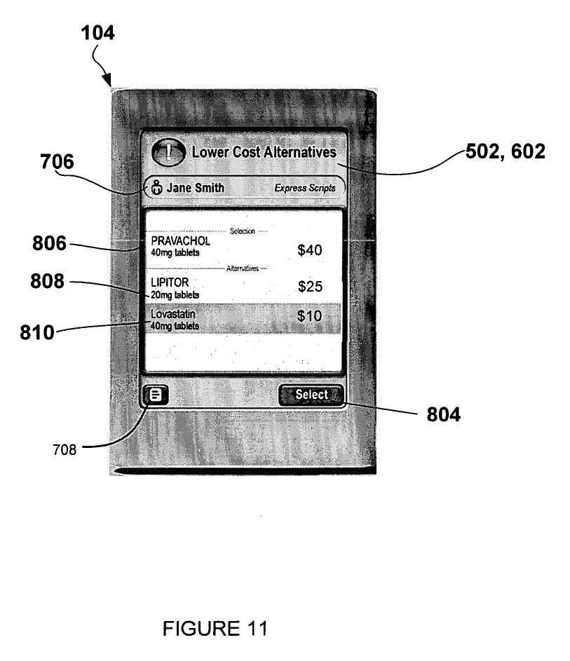

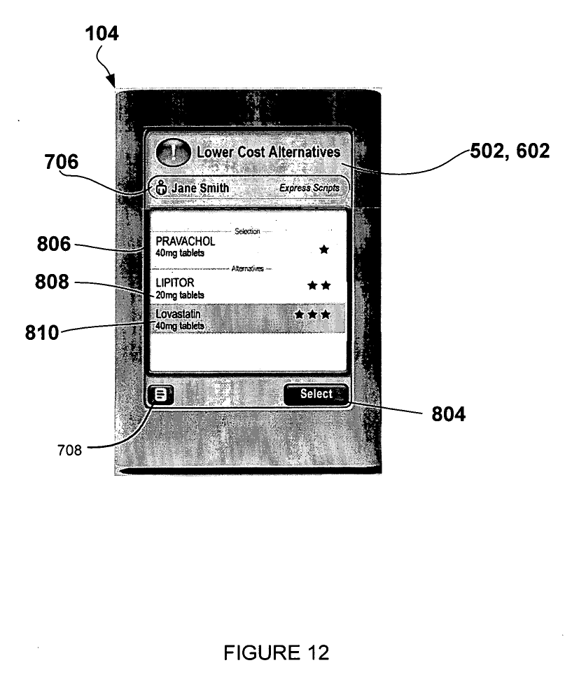

Accordingly, in step 407, the electronic prescribing device 104 displays the prescription medication selected by the prescriber 102 and the more preferred alternatives prescription medications, if any, that are available to the patient based on the formula of the patient's health plan, together with their exact dosage based on the drug equivalence mapping from the third party data provider 306 and the health information entity 116. (See, for example, FIGS. 11 and 12.) With the invention, the prescriber 102 is able to view instantaneously and conveniently the preference status for the selected medication and the alternative medications, and is able to select a prescription medication so that the patient can, if the prescriber 102 considers it prudent, receive the higher preference status prescription medication, which is very likely, to be the lower cost medication under most circumstances.

The display of a limited number of alternative prescription medications to the prescriber 102, such as the most preferred alternatives, reduces the number of choices, confusion, time and frustration in processing the various different formulary for various different health insurance entities. Moreover, the alternatives may be displayed based, at least in part, on the individual prescriber's pre-established medication preferences. The doctor's office centralized computer system 202, EMR, and/or POMIS may be queried to obtain data including at least one of the patient's name, their health insurance entity (which may include a government type plan such as Medicare), and other prescription critical data to ensure proper dosage.

At step 408, the prescriber 102 may select one of the prescription medications for filling. In step 409, an optional step of verifying the prescription medicine may be displayed on the electronic prescribing device 104 as shown in FIG. 3. In particular, the electronic prescribing device 104 may show at least one of the prescription medicine name, the dosage form and amount, the quantity, SIG, and refill number for verification by the prescriber 102, as is known in the art. Verification is made by input from the prescriber 102 to the electronic prescribing device 104 as shown by step 410 in FIG. 5.

In step 411, the prescriber 102 may now add the selected prescription medicine to a virtual shopping cart or “cart”, similar to conventional internet purchasing systems known in the art. The virtual cart or shopping cart is a software component that acts as a cataloging and ordering process. The virtual cart is the interface to the deeper infrastructure of the electronic prescribing device 104, allowing the prescriber 102 to select prescriptions; review what prescriptions they have selected; make necessary modifications or additions; and then complete the prescription process. Thereafter, the prescriber 102 may send the prescription medicine to be filled or may add additional prescription medications to the cart, as described below.

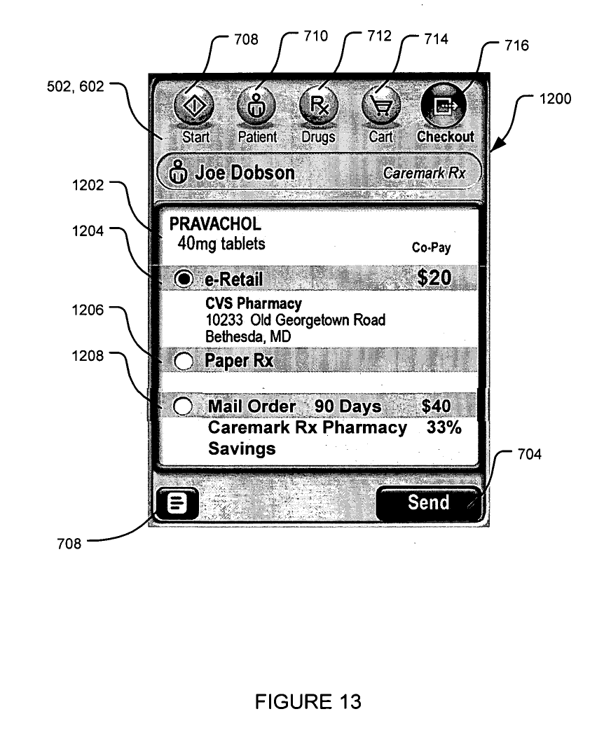

In step 413, the prescriber 102 is now able to choose a particular pharmacy requested by the patient to send this electronic prescription medication and, accordingly, where it is dispensed. In particular, the doctor's office centralized computer 202 data base, EMR and/or POMIS systems may store the patient's preferred pharmacy 112 data or the patient's usual pharmacy may be obtained from one of the PBM's 118, 120, 122. After consultation with the patient at the point of care, the prescriber 102 is able to either select the patient's preferred pharmacy, 112, a paper script to be printed on a printer 204 for the patient's use or send the prescription to a mail order pharmacy 350 as shown in step 416. (FIG. 13 shows an exemplary pharmacy selection screen.) The mail order pharmacy 350 may act in conjunction with the health information entity 116 instead of the fulfillment entity 114 as is well known in the art.

Finally, in step 415, if the prescriber 102 has chosen a particular pharmacy 112 and thus the electronic prescription alternative, the electronic prescribing device 104 then sends the prescription to the pharmacy 112 via the centralized computer 202, the data center 112 where the request is sent to the electronic fulfillment entity 114 that operates with the retail pharmacy 112, as noted above, by transmission 310.

The software and hardware configured to execute the process of steps 401-415 in FIGS. 3-5 are configured so that the process can take place in less than 20 seconds, and preferably 15 seconds. This further encourages the acceptance of electronic prescribing by the prescriber 102.

It should be noted that the particular flow, screens and logic of FIGS. 3-5 are merely exemplary. In this regard, different screens, different flow of logic, different routes of transmission and the like may be used and are contemplated by the invention.

FIG. 6 is a portion of the flow diagram showing more detailed exemplary logic to accomplish the LCA alerting mechanism for step 407 of FIG. 4. After the prescriber 102 has selected a particular prescription drug in step 406, the process may follow step 407 shown in greater detail in FIG. 6. The first step 502 determines whether the initially selected drug has the most preferred status, e.g., the highest formulary status and has no generic substitute. If the selected medication is the most preferred prescription medication that has no generic, then the flow of logic will go straight to step 411 shown in FIG. 6. In this case, no alternatives are displayed and the prescription drug will be automatically added to the cart. If the selected medication is not most preferred, the flow of logic moves to step 504.

In particular, it may be determined then whether or not there is a generic equivalent with the most preferred status that is equivalent to the selected drug by the prescriber 102 in step 406. If a generic exists having the most preferred status, then the flow of logic may go straight again to step 411 shown in FIG. 6, in which case no alternatives are displayed and this generic prescription drug will be added to the cart. Then, the process may return to the process shown in FIG. 5 and step 412.

In the case where a generic equivalent with the most preferred status does not exist, then the logic will move to step 506. In step 506, various third party data providers 306 (shown in FIG. 3), including, for example, pharmacy databases, drug reference databases, equivalents databases and drug databases, may be queried to find all dosage equivalents to obtain all equivalent drugs. Next, in step 508 the process may determine the preference status, e.g. the formulary status, for each of these equivalent drugs. Next, in step 510 it may be determined whether or not an equivalent drug with the most preferred status exists. If an equivalent drug with the most preferred status does exist, then the flow of logic may move to step 512. In step 512, all of the prescription drugs having a preference status greater than the drug that was selected originally by the prescriber 102 in step 406 are listed together with the originally selected drug. Such a listing is displayed on the device as shown in FIGS. 11 and 12 as discussed in greater detail below and may include an icon representative of the preference status, such as co-pay tier of the prescription drug (see FIG. 12), the approximate co-pay with respect to that particular drug, and/or the adjudicated or true cost of the prescription medication (see FIG. 11). As shown in FIG. 12, a greater number of symbols such as ★'s is indicative of a more preferred status, but any other system could be employed such as $, in which case a few number of $'s may indicate more preferred status. The LCA step in the process is then completed at step 407 and the flow returned to step 408 of FIG. 4.

If, on the other hand, in step 510, there is no equivalent drug with a higher preference status than the initially selected medication at step 406, the flow of logic may move to seek class alternative drugs in step 514. In step 514 again the databases shown in FIG. 3 at reference numeral 306 including, for example, the pharmacies databases, drug reference databases, equivalence databases, and drug databases, may be queried to get the class alternative drugs. Thereafter in step 516 the preference status for each of these class alternative drugs may be determined. The flow of logic then turns to step 512 where the most preferred drugs based upon preference status may be listed on the LCA screen, such as at FIGS. 11-12. Thereafter, logic flow will return to step 408 of FIG. 4.

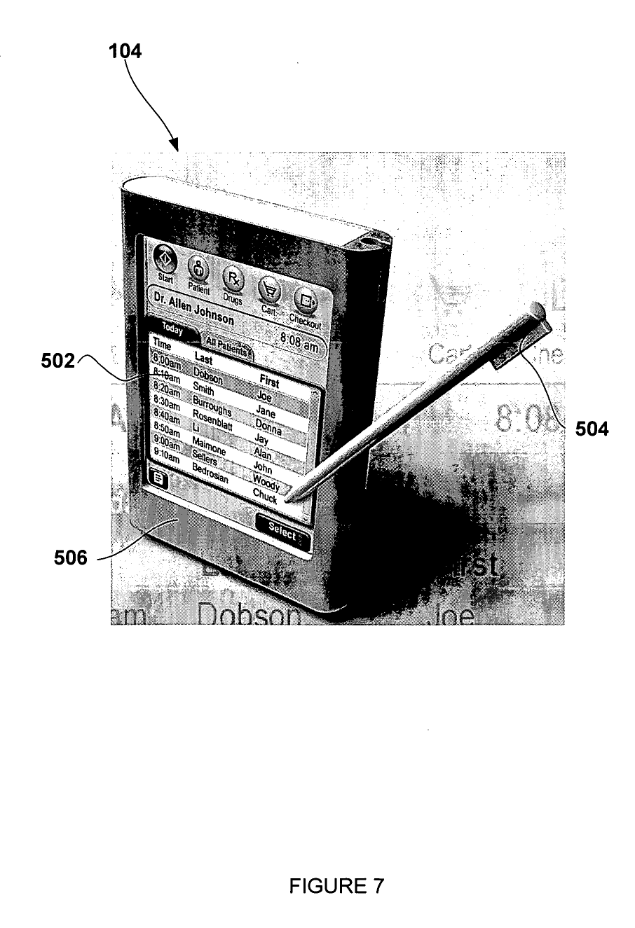

FIG. 7 shows an exemplary embodiment of a portable, hand-held electronic prescribing device 104 constructed according to the principles of the invention. In particular, the electronic prescribing device 104 shown in FIG. 7 includes a display 502. The display 502 can be any known type of liquid crystal display or any other known display type. The electronic prescribing device 104 also includes a hand-held component housing 506 that contains all of the electronic components that are part of the electronic prescribing device 104, such as a transceiver including an antenna, memory, input-output devices, a central processing unit, a battery, microphone with voice responsive software and all other structure known to those of ordinary skill in the art. Additionally, the electronic prescribing device 104 may include an input device 504 used in conjunction with the display 502. In particular, the device 504 may employ a stylus together with a touch sensitive surface on the display 502 as an input device. Any other known input or interface may be employed including a voice responsive input with voice recognition capabilities to receive voice commands and/or actions from the prescriber.

In a specific implementation of the electronic prescribing device 104, a Hewlett Packard (HP Palo Alto, Calif.) iPAQ pocket PC or a Dell (Round Rock, Tex.) Axim may be employed as the electronic prescribing device 104. The device 104 may be configured to operate only as a dedicated prescribing device, or in other words, “kiosk mode.” Thus, other software functionality such as word processing and spreadsheets are not provided. Device 104 is configured in kiosk mode in order to limit the usage of the device 104 to electronic prescribing. This will reduce the extraneous uses of device 104 and the applications that would be used with such extraneous use. However, any type of computerized platform may be employed.

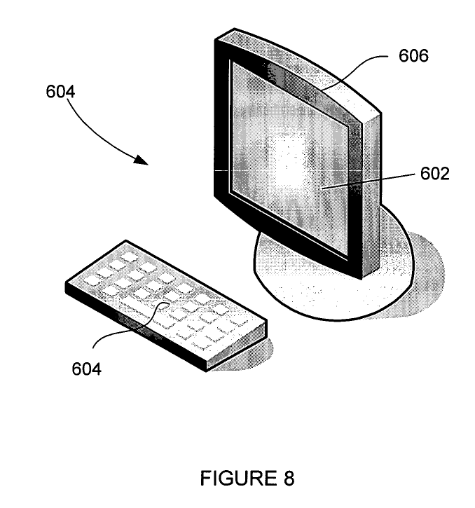

FIG. 8 shows another embodiment of an electronic prescribing device 104 constructed according to the principles of the invention, in which a personal computer is implemented as the electronic prescribing device 104. In this embodiment, the electronic prescribing device 104 includes a housing 606, a display 602 and an input device 604, such as a keyboard. The software may have the same look and feel as used in hand held embodiment or may be web-based with any look and feel known in the art.

FIG. 9 shows an exemplary enlarged view of the patient selection screen display according to step 401 of FIGS. 3 and 4 provided on the electronic prescribing device 104, 604 of the invention. The display 502, 602 has been designed to facilitate the ease, intuitiveness and speed of the electronic prescription process of the invention to ensure its widespread use and acceptance. The display 502, 602 may include a listing of patients 702 associated with a given doctor or prescriber 102. The device 104 may be used by more than one prescriber 102, so the user may first input which prescriber 102 is using the electronic prescribing device 104. In the exemplary embodiment shown in FIG. 9, the patients are listed by the time of their appointment. In particular, a left column shows a patient's particular appointment time. The middle and right columns shows the patient's last and first name, respectively. Additionally, the display 502, 602 of the electronic prescribing device 104 includes the doctor's name and a series of menu/navigation buttons 708, 710, 712, 714, and 716. In particular, button 708 may start the patient care process. Button 710 may take the user to the patient listing such as that shown in FIG. 9. Button 712 may list all of the possible prescription medications as shown in FIG. 10 described below. Button 714 may show what prescriptions have been added to the cart for a particular patient. Button 716 initiates the checkout process in which the prescription is sent to a pharmacy as noted above and shown in FIG. 13. Additionally, display device 502, 602 includes a selection button 704 that has a dynamic function with each screen. In particular, a prescriber 102 picks one of the patients from the listing 702 and clicks the select button 704 in order to go to the next step of the prescription process. Additionally, display device 502, 602 may include various other input buttons and/or devices and other known input types.

The button 718 is a context sensitive pull-up menu button which provides access to additional functionality, outside the core prescribing process, which is relevant to the data and display “context” on a given screen. For example, button 718 may provide an additional lower cost alternatives screen. As another example, button 718, in conjunction with steps 413 and 414, by default, displays the last or most commonly used retail pharmacy for the specific patient (with information derived from patient claims data) as the logical option for retail pharmacy fulfillment. However, if the prescriber 102 or the patient would like to change the pharmacy choice, then it is possible to access a list of other pharmacies via button 708. The display shown in FIG. 9 has been carefully chosen to facilitate use and acceptance, other input areas and display portions may be employed. However, other arrangements of arrangements having more or less features and different arrangements thereof may not achieve all the benefits of the invention.

FIG. 10 shows an exemplary display of the drug selection screen according to step 405 shown in FIG. 3 and FIG. 4. In particular, like reference numerals of FIG. 10 refer to the same functions as previously described. Moreover, FIG. 10 now shows an alphabetical listing of various prescription medications 1002. The drugs in all caps are brand name drugs while those in initial caps are generics. The listing of prescription medications 1002 includes a navigation slidebar 1004 to be able to quickly go up and down the listing 1002. Moreover, the prescriber 102 may highlight a particular drug as shown by 1008. Thereafter, the prescriber may then press the select button 704 to choose this medication and move forward to the subsequent steps as set forth above.

FIGS. 11 and 12 show embodiments of the LCA alert screen according to step 405 of the invention, which also has been carefully designed to speed the electronic prescription process and facilitate its use and acceptance, as well as drive physicians to create cost savings for patients and other stakeholders. In particular, FIGS. 11 and 12 show at 806 the initial medication selected by the prescriber 102 (PRAVACHOL) together with the dosage (40 mg), and an approximate co-pay, total co-pay or the cost (as shown in FIG. 11) or a preference status icon (as shown in FIG. 12). The electronic prescribing device 104 further shows on the display device 502, 602 below the originally selected drug (PRAVACHOL) at 808 and 810 all of the more preferred alternatives (Lipitor and Lovastatin), together with their dosage amounts (second line) and the cost information. The prescriber 102 can then select one of the three prescription medication choices 806, 808, 810, being cognitive of their respective preference status or cost. The prescriber 102 then uses the stylus or other input device to highlight the particular prescription medication 806, 808, 810 and then presses the “Select” button 804 to add this particular prescription medicine to the cart of for this patient.

Again, while the LCA alerting screens of FIGS. 11 and 12 have been carefully designed to facilitate use and acceptance of the electronic prescription process, it is an exemplary arrangement of input areas and display portions. Other arrangements having more or less features and different arrangements thereof are contemplated by the invention, but may not achieve all the benefits and advantages of the invention.

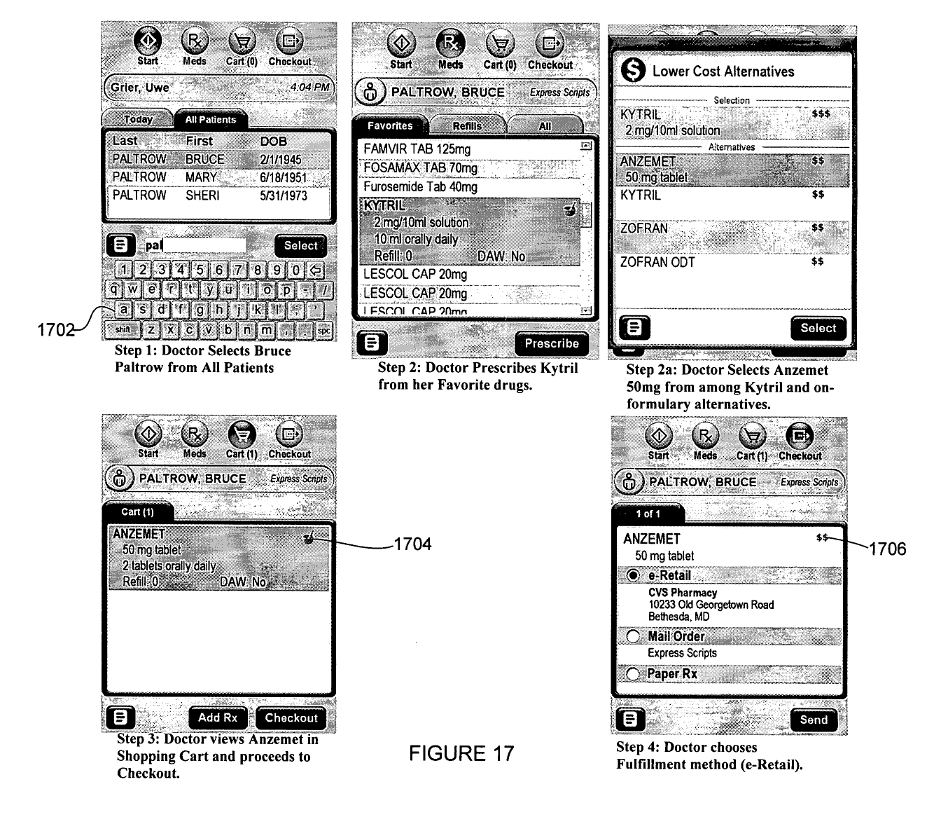

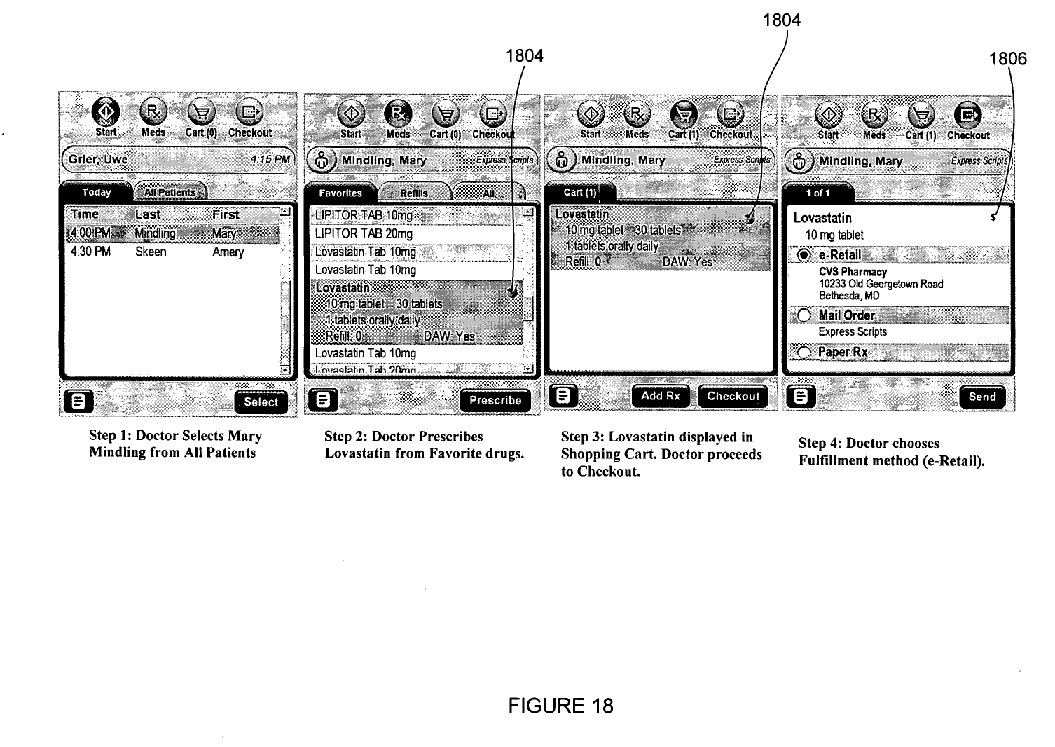

FIG. 13 shows the checkout screen 1200 for the display 502, 602 in which the prescriber may choose a desired fulfillment method. In particular, the checkout screen includes the chosen drug at 1202 together with up to three different fulfillment choices. An electronic retail or “e-retail” is shown at 1204 together with the approximate or total co-pay amount (or the true cost) as appropriate based upon the patient's health plan coverage, as discussed in more detail in connection with FIGS. 17-18 below. Moreover, the e-retail 1204 may include the pharmacy name and its specific address. Further shown on the pharmacy selection screen 1200 is a choice for paper or script-type printout shown at 1206. Accordingly, if the prescriber 102 chooses a paper script to be printed, the radio button along side the paper script choice 1206 may be selected and the script will be printed on a printer in communication with the device, such as a printer in the prescriber's office. Finally, the prescriber 102 may choose the mail order option at 1208. Again, the prescriber 102 may select the radio button or similar input device at 1208 and press the send button 1210 to send the prescription request to the e-retail at 1204 or the mail order pharmacy at 1208.

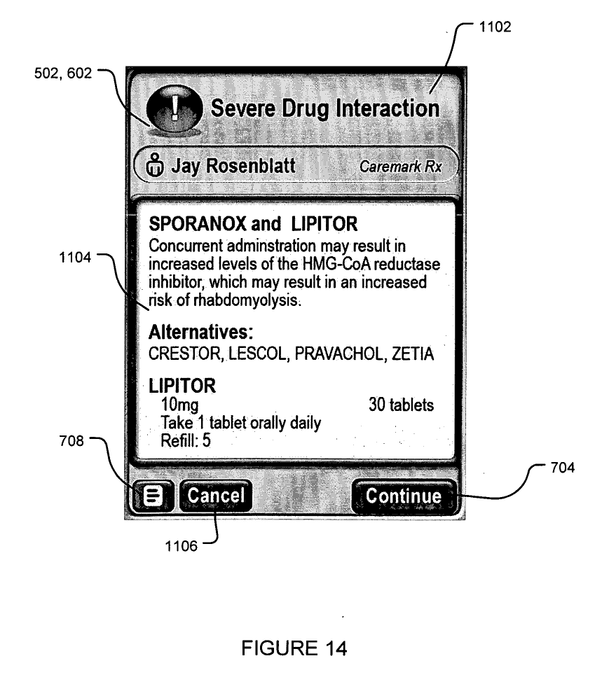

FIG. 14 shows the display 502, 602 screen for a severe drug interaction alert 1102 of the invention. In particular, the severe drug interaction alert screen 1102 includes a description of the drug having the severe interaction 1104. Moreover, the severe drug interaction screen 1102 may include a short description of the issues involved with the severe drug interaction drug 1104 and may include alternatives thereto. Additionally, the severe drug interaction alert screen 1102 may include a cancel button 1106. Pressing the cancel button 1106 may remove this drug from the cart. Additionally, the display 502, 602 includes a continue button 1108 which provides for the continued prescription of this particular drug in spite of the severe drug interaction alert screen 1102. The severe drug interaction alert operates based on an algorithm similar to the FIG. 6 LCA alert for alternative medications. Accordingly, there will be a series of checks based on the various interactions of drugs that cause severe drug interaction and the alert will prompt the screen 1102 as described above.

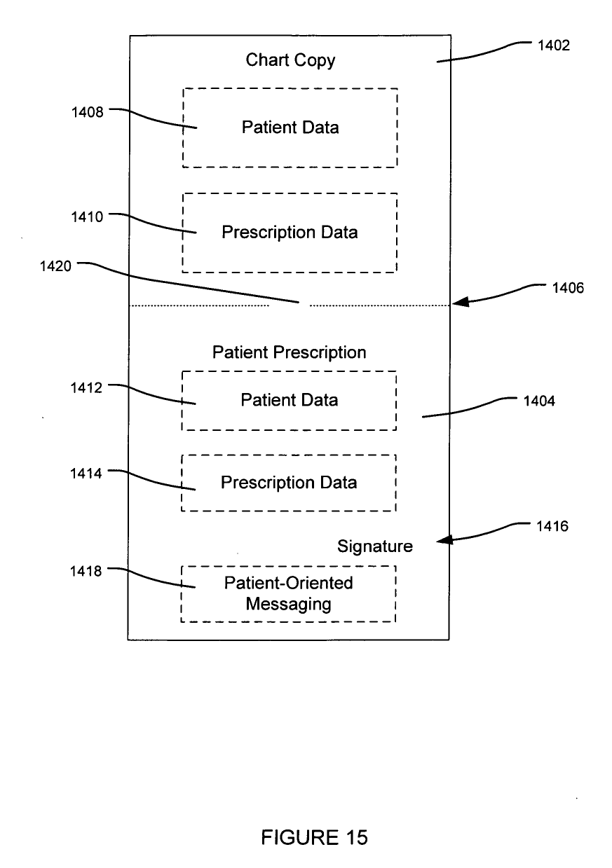

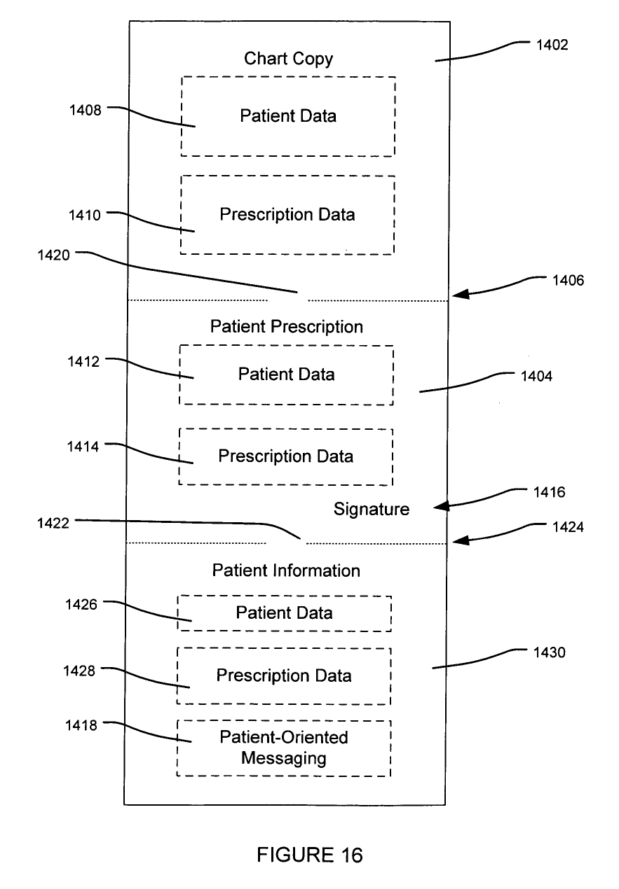

FIG. 15 shows an exemplary printed prescription script constructed according to the principles of the invention. In particular, when a prescriber chooses at step 416 as shown in FIG. 5 to print the script at a printer in the prescriber's office (such as the printer 204 shown in FIGS. 2 and 3), the script may print out with or without a chart copy as shown in FIG. 15. In particular, the prescriber may activate the radio button 1206 on the check out screen shown in FIG. 13. The prescription may print out a multi-part form having two portions or sheets as shown in FIG. 15 (if the prescriber desires a chart copy) or three (or more) as shown in FIG. 16 discussed below. More particularly, a first portion 1402 may be printed for the physician's records, i.e., a chart copy, along with a second portion 1404 that may be the actual patient prescription. The prescriber controls whether or not a chart copy is printed on a script by script basis. However, the device may default to the prescriber's preferred behavior.

In one exemplary embodiment, the patient prescription does not print if it is sent electronically. Printing of the chart copy may be optional and based on the decision of the prescriber. The patient information sheet also may be optional and based on the decision of the prescriber (and the patient). However, if there is a patient oriented message, printing of the message may not be optional regardless of the fulfillment method selected and the patient prescription and/or on the patient information sheet having the patient oriented message is printed.

In a further exemplary embodiment, the chart copy 1402 may be frangibly or partially attached to the patient prescription 1404, e.g. by the remaining portion 1420 left after a partial cut is made at 1406 to create the two portions. For example, a cutter within printer 204 may make a partial cut allowing the two copies to remain connected for the prescriber's use until which time one portion can be easily detached and given to the patient and the other portion entered into the patient's file. The partial cutter may be any type of cutter as is known in the art. Of course, other types of frangible connections may be employed.

The chart copy 1402 may include a patient data section 1408 including the patient's name, address, date of birth, date and time and the like. Moreover, in another section the prescription data 1410 may also be included which lists the medication type, quantity, refill, and the like. The patient prescription portion 1404 may include similar sections. In particular, a patient data section 1412 again includes the patient's name, address, date of birth, date and time, and the like. The patient prescription 1404 may also include a section of the prescription information 1414 including the prescription type, quantity, refill, duration, and the like. Additionally, the patient prescription portion 1404 may further include an additional messaging or information section 1418. The additional printed section may include consumer-oriented messaging including various different sponsored messaging such as advertisements or reminders. In particular, the consumer-oriented messaging may include various information on this patient's prescription portion 1404 including health and wellness programs, website addresses to drive traffic to a particular website, or mail order fulfillment instructions. Moreover, this particular section 1418 may further include customized messaging including, for example, medication instructions, therapeutic class messages, etc. Of course, any type of graphical or textual-type messages are contemplated for this particular area and this particular area may be customized in any way, shape or form.

FIG. 16 shows another embodiment of a printed script as a 3-part form with two frangible connections of 1420 and 1422 that divide the script into a chart copy, a patient prescription, and a separate patient information section. More specifically, a first chart copy portion 1402 for the prescriber's records may be printed, along with a patient prescription portion 1404, and a third information portion 1430, which may also be frangibly connected, e.g., by being partially attached to the patient prescription copy 1404 by a remaining portion 1422 left after a partial cut 1424. Information portion 1430 may include a patient data section 1426 including the patient's name, address, date of birth, date and time and the like, a prescription data 1428, which lists the medication type, quantity, refill, and the like, and a consumer-oriented messaging section 1418 as previously discussed above. In this embodiment, the physician may control whether or not to print a chart copy, as noted above, but the patient information portion may always print whenever a script is printed.

FIGS. 17 and 18 show examples of operation of the LCA alerting mechanism of the invention in which formulary status is used to determine the most preferred status of a drug. In the example of FIG. 17, after a prescriber selects a clinically appropriate drug, the LCA alert process presents the prescriber with formulary and therapeutic alternatives when alternatives are available at a higher formulary status than the selected drug. In FIG. 17, formulary status is represented iconically with $ where one $ represents most preferred and one $ is added for each lower formulary status (i.e. four $$$$ represents uncovered drugs for Express Scripts). In all cases formulary status may also be presented in the Checkout fulfillment screen. A typical prescribing scenario is discussed below in connection with FIG. 17.
1. The prescriber selects patient ‘Bruce Paltrow’ at step 1 and then chooses to prescribe the drug ‘Kytril’ at step 2. In particular, note that the display screen shown in step 1 further includes a virtual keyboard 1702. In this case the user can use a stylus to touch the virtual keyboard 1702 to provide input to the device.
2. As shown at step 2, ‘Kytril’ is not on formulary for the patient.

3. The invention presents ‘Anzemet’, ‘Kytril (tablet forms), ‘Zofran’, and ‘Zofran ODT’ as on-formulary alternatives in the LCA screen at step 2.

4. The physician selects ‘Anzemet’ as a substitute for ‘Kytril’ and ‘Anzemet’ is added to the cart screen at step 3. Moreover, notice that the screen shot of step 3 includes additional information for the selected drug ‘Anzemet’. In particular, note that it lists various data of that particular prescription medication including the dosage, SIG, refill information, and the like. Moreover, the display of step 3 can further indicate other criteria such as whether this particular prescription medication is available over the counter. In this case, the icon 1704 indicates that ‘Anzemet’ is not available over the counter.
5. The prescriber then proceeds to the checkout screen at step 4 where the prescriber selects the fulfillment method desired. The prescriber chooses e-retail fulfillment to complete the prescription process. Note, the checkout screen may show fulfillment cost information, e.g., with an icon 1706 (which may be based on the coverage of a patient's health plan and not formulary based) only when there is a difference in cost (based on coverage) between retail and mail order pharmacies. In other words, this icon may indicate that there are differences in cost depending upon the type of fulfillment, whether it be retail pharmacy, internet pharmacy, mail order pharmacy (or whatever other type of fulfillment options are available).

In the example of FIG. 18, when a prescriber chooses a clinically appropriate drug for which no higher formulary status alternatives are available, no alternatives are presented, thereby allowing the physician to progress quickly through the prescription process. Formulary status of the selected drug may be presented in the Checkout fulfillment screen. A typical prescribing scenario is described below in connection with FIG. 18.
1. The prescriber selects patient ‘Mary Mindling’ at step 1.
2. The prescriber selects the generic drug ‘Lovastatin’ (note that generics are presented as mixed case on the screen) at step 2.
3. As a generic, ‘Lovastatin’ has the most preferred formulary status, so no alternatives are presented (i.e. there is no LCA screen) and ‘Lovastatin’ is directly added to the shopping cart at step 3. Note again the icon 1804 indicates that the medication is not available over the counter.
4. The prescriber then proceeds to checkout at step 4 where the formulary status for ‘Lovastatin’ is displayed. The prescriber chooses retail fulfillment to complete the prescription process. Again, the step 4 display may show fulfillment cost information with an icon 1806.

The invention also provides a revenue model that enhances the acceptance and implementation of the electronic prescribing system. At least one barrier to the acceptance of electronic prescribing has been the initial cost of implementing the system. The invention enables the electronic prescribing system, as described above, to be provided to a prescriber 102 and/or maintained at no cost or reduced cost. The cost of the prescribing system is borne or subsidized by the stakeholders and users associated with the prescription medication industry and insurance industry that interact with the prescriber 102. The use of the electronic prescribing device of the invention provides numerous benefits and savings to various entities who have a large stake in the multi-billion dollar drug prescription industry and should be willing to pay for these benefits and savings.

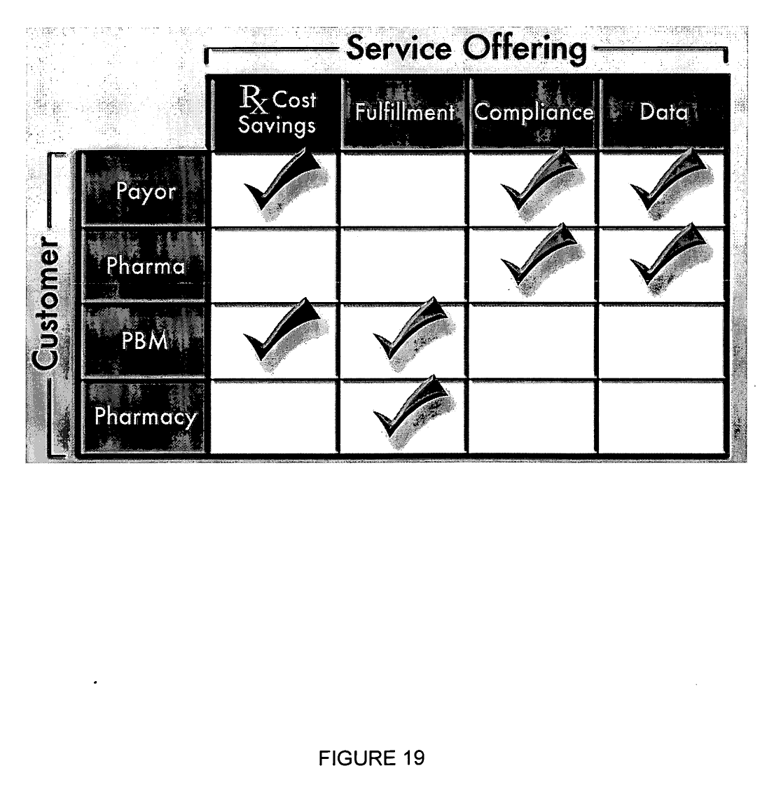

In particular, as shown in FIG. 19, at least four types of “stockholders” benefit from the electronic prescribing of prescription medications in at least four different ways. More specifically, the left column shows some of the exemplary customers as the health insurance entity (Payor), the pharmaceutical companies (Pharma), the pharmacy benefit managers (PBM) and the pharmacy industry. Each of the columns show the areas of potential savings these customers, including savings in the cost of the actual pharmaceutical prescription medications, fulfillment of prescription, compliance, and the medical data generated by electronic prescription. These benefits and savings are described in more detail below. It should be noted that other stakeholders may exist and other forms of cost savings may be achieved by these stakeholders.

The health insurance entity (Payor) benefits from the electronic prescription system of the invention when the prescriber 102 is shown various alternative, preferred prescription medication choices based on the health insurance provider's formulary. By showing the prescriber 102 the preferred prescription medicine alternatives, the prescriber 102 is more likely to choose an alternative prescription medication instead of the higher price prescription medication. The health insurance entity then saves money by the prescriber 102 choosing the alternative prescription medicine. The health insurance entity may have special arrangements with particular pharmaceutical manufacturers that allow for a cost savings when a patient is prescribed a preferred prescription medication based on the health insurance entity's formulary. This results in a prescription medicine cost savings (Rx cost savings).

Additionally, the invention has direct medical benefits as well. Because the electronic prescribing device 104 shows the prescriber 102 the patient's drug history, including other currently prescribed medications, regardless of who prescribed them, along with patient allergies the prescriber 102 is more likely to avoid prescribing medicines that adversely react with the patient's currently prescribed prescription medications. Accordingly, there will likely be fewer hospitalizations and fewer deaths caused by incorrect prescription medicine prescribing based on not knowing what other prescription medications have been prescribed for this particular patient. This problem is exacerbated by the growing number of drugs and growing number of patients on multiple drugs simultaneously. Thus, the invention further reduces costs for the health insurance entity.

Additionally, the invention achieves benefits in compliance as the prescriber and/or payor may receive an indication or report of whether or not the prescription medication has been purchased by the patient at the pharmacy 112. Compliance with the prescriber 102 prescriptions ensures that the patient is more likely to benefit from the prescribing of the prescription medicine, and adverse health conditions caused by patients not taking their medications are avoided, thereby reducing costs to the health insurance entity (payor). In particular, when the patient obtains the prescribed medicine 112 the health insurance entity is charged for it, and information which is indicative of patient picking up the medicine, is returned from the pharmacy 112 to the electronic fulfillment entity 114 through data center 112 to the health information entity 116. So, the payment information constitutes compliance information that provides an indication of whether or not the patient has picked up the medicine and therefore whether or not the patient most likely takes the medicine.

Additionally, the health insurance entity (Payor) benefits from the data collected indicating a prescriber's 102 actions with respect to prescribing specific drugs. In this regard, the data center 112 collects data based on actions of the prescribers with respect to the electronic prescribing device 104. In particular, data showing how prescribers are prescribing medicine when given certain choices is collected by the data center 112. Such data includes the prescriber's 102 input for steps 406-411 described above. This data is indicative of the prescriber's 102 actions and is useful to gain insight to the critical thinking or decision process of the prescriber 102. This data has a specific value for cost marketing and other purposes.

Accordingly, the health insurance entity (payor) receives numerous benefits or savings from the invention, including savings from the particular formulary which the prescriber 102 chooses, benefits from compliance (knowing that the patient has purchased the prescription medications), and benefits from data generated and collected based on the prescription made by the electronic prescribing device 104.

The pharmaceutical manufacturers (Pharma) also benefit from the use of the invention. In particular, pharmaceutical manufacturers may benefit from knowing whether or not a particular prescribed medicine is purchased though the compliance checking and also benefits from the data collected by the electronic prescribing device 104 and the data center 112 for at least the reasons noted above. Additionally, pharmaceutical manufacturers are interested and should be willing to pay for the information showing when a prescriber 102 picks an alternative medicine in lieu of the originally selected prescription medication during steps 407 and 408 described above. The pharmaceutical manufacturer also benefits from the aggregated data regarding initial prescriber prescription medication choices (step 406) and final prescription medication choices (steps 407 & 408). In this regard, the pharmaceutical manufacturer is able to get almost instantaneous feedback from the marketing of the prescription medications from the data based on the prescriber choices (inputs or clicks). Current marketing data may be obtained more slowly and is more likely to be subjective.

The pharmacy benefit managers (PBM) also receive cost benefits from the use of the invention. In particular, the pharmacy benefit managers also receive a cost savings through the use of a particular pharmaceutical prescription medication. They also receive a savings through the fulfillment entity 114 for the automated fulfillment of the prescription medication that may reduce their operating costs.

Finally, the pharmacy filling the prescription also receives a benefit from the use of the invention. In particular, pharmacy 112 receives a higher throughput of prescribed medicines together with a lower overhead (no cost of data entry) through a completed electronic transaction. In other words, the fulfillment of the prescription at the pharmacy creates a lower overhead for the pharmacy. The pharmacy receives a more accurate interpretation of the prescription (i.e., pharmacist does not have to read hand written script) and there will be less chance of wrong drug and reduced liability.

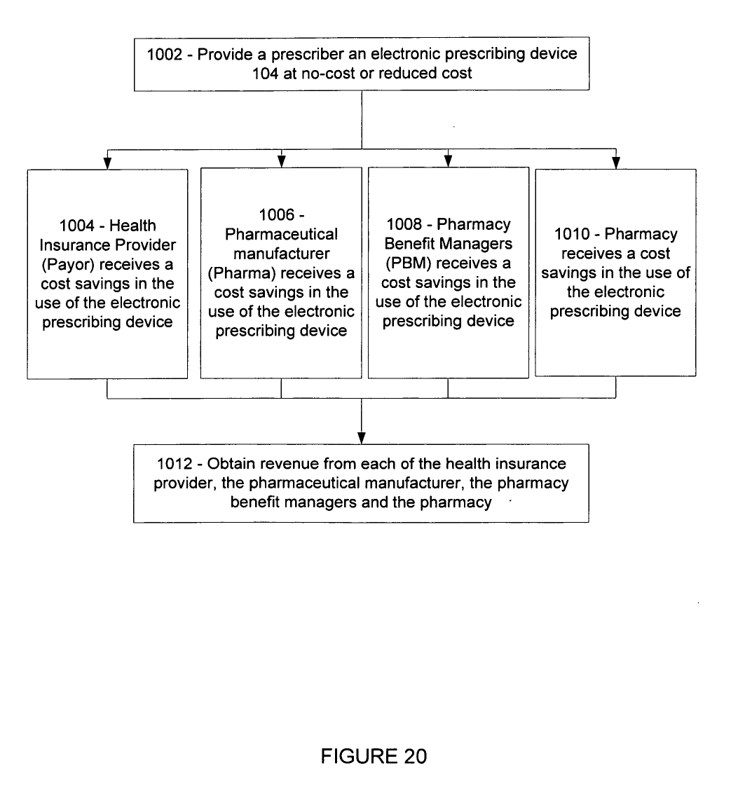

FIG. 20 shows a revenue model implemented according the principles of the invention to make electronic prescribing cost effective and accepted. In this model, each of these entities, including the health insurance entity, the pharmaceutical companies, the pharmacy benefit managers and the pharmacy, who receive a cost savings, compliance information or other apparent and non-apparent benefits, in the use of the electronic prescribing device 104 of the invention may be charged according to the value of the benefit or savings they realize. In this regard, the implementer of the data center 112 is able to provide an ongoing service of transactional information which may derive revenue (e.g., charge fees for specific or aggregated transactional type information) from one or more of the health insurance entity, pharmaceutical companies, the pharmacy benefit managers and the pharmacy. In this model, the operator of the data center 112 can provide at no-cost or reduced cost to a doctors office or medical facility an entire electronic prescribing system, including one or more devices 104 for each examining room and/or prescriber 102, the WLAN 208, the transmitter 206, the printer 204, the centralized computer system 202 software and any other equipment or supplies needed to practice the invention as shown in step 1002 of FIG. 20. The health insurance entity, the pharmaceutical companies, the pharmacy benefit managers and the pharmacy, each receive a cost savings or benefits in the use of the electronic prescribing system as shown by steps 1004, 1006, 1008, and 1010. In return, an operator of the data center 112 obtains revenue, as shown in step 1012 from one or more of the health insurance entity, the pharmaceutical companies, the pharmacy benefit managers and the pharmacy for providing a valuable service and/or information, such as statistical and/or demographic information for their optimizing business operations and strategic decision making, and/or reducing their costs.

In the invention, the revenue that is obtained from the use of the electronic prescribing device 104 may be transaction based or may be service based. A per transaction revenue source may include the filling of a prescription, the filling of an alternate prescription based on a display thereof with respect steps 407, 408 (prescriber changing their mind to use another medication), and the like. A service based revenue may include aggregated data of prescription medication choices including initial choices in conjunction with step 406 and choices based on step 407, 408 (prescriber changing their mind to use another medication).

Accordingly, in this revenue model, the target prescriber entity is more likely to choose the electronic prescribing system of the invention and use it with the data center 112 because it is being provided at a reduced cost or free to the prescribing entity. The other entities including the health insurance entity, the pharmacy 112, the PBMs 118, 120, 122 and the pharmaceutical companies receive benefits, such as cost savings, and should be willing to pay the operator of the data center 112 for those reduced costs and other apparent and non-apparent benefits.

It should be noted that a specific implementation of the electronic prescribing device 104, as previously discussed, is not needed with the second revenue generation aspect of the invention. However, both the electronic prescribing device 104 and revenue generating aspect of the invention are intended to work together.

In accordance with various embodiments of the invention, the methods described herein are intended for operation with dedicated hardware implementations including, but not limited to, semiconductors, application specific integrated circuits, programmable logic arrays, and other hardware devices constructed to implement the methods and modules described herein. Moreover, various embodiments of the invention described herein are intended for operation as software programs running on a computer processor. The flow diagrams may also represent block diagrams of components for performing the steps thereof. Furthermore, alternative software implementations including, but not limited to, distributed processing, component/object distributed processing, parallel processing, virtual machine processing, any future enhancements, or any future protocol can also be used to implement the methods described herein.

It should also be noted that the software implementations of the invention as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to email or other self-contained information archive or set of archives is considered a distribution medium equivalent to a tangible storage medium. Accordingly, the invention is considered to include a tangible storage medium or distribution medium, as listed herein and including art-recognized equivalents and successor media, in which the software implementations herein are stored. The software implementations may also be transmitted over and embodied in carrier waves which may be read and executed by a computer processor.

While the invention has been described in terms of exemplary embodiments, those skilled in the art will recognize that the invention can be practiced with modifications in the spirit and scope of the appended claims. These examples given above are merely illustrative and are not meant to be an exhaustive list of all possible designs, embodiments, applications or modifications of the invention.

What is claimed:

1. An electronic medical prescription device for prescribing medication to a patient, said device comprising:
a display having a first screen configured to list prescription medications in response to a request to prescribe medication to a patient;
an input that allows selection of one of the prescription medications on said display; and
a processor configured to determine and display, in response to the selection of one of the prescription medications, a second screen showing the selected prescription medication, together with alternative prescription medications having equal or more preferred status than the selected prescription medication, if any exist, as determined by the patient's health plan.

2. The device according to claim 1 wherein said processor is further configured to determine and display on said second screen a relative ranking factor indicative of the preference status of the displayed selected prescription medication and the alternative prescription medications, if any exist.

3. The device according to claim 2 wherein the relative ranking factor comprises a graphical representation indicative of at least one of a co-pay tier, approximate co-pay, adjudicated cost, formulary status and health plan preference.

4. The device according to claim 1 wherein said first screen displays prescription medications without showing any indication of formulary status.

5. The device according to claim 4, wherein said second screen displays the prescription medications along with an indication of their formulary status to automatically alert the user as to the formulary status of the displayed medications.

6. The device according to claim 5, wherein the display of formulary status on the second screen is generated automatically with each displayed medication and is not user selectable.

7. The device according to claim 1 wherein said second screen displays all alternative prescription medications that have a more preferred status than the displayed selected prescription medication, if any, as determined by the patient's health plan.

8. The device according to claim 1 wherein said processor is further configured to determine and display on said second screen the dosage of the displayed selected prescription medication and the equivalent mapped dosage of the alternative prescription medications.

9. The device according to claim 8 wherein said second screen is further configured to allow selection of one of the selected alternative prescription medications in order to prescribe to a patient.

10. The device according to claim 1 wherein said processor displays a cart screen in response to selection of one of the selected or alternative prescription medications, said cart screen displaying at least one of the names of the medication, the dosage, the preference status, the SIG, and refill information for the selected medication prior to ordering the medication.

11. The device according to claim 10 further comprising a checkout screen configured to allow ordering of the selected medication by selection of a specific drug fulfillment entity to electronically send the prescription or print the prescription on paper.

12. The device according to claim 11, wherein said cart screen allows a user to add further prescriptions prior to ordering the selected medication via said checkout screen.

13. The device according to claim 1 wherein said processor selects the alternative prescription medications based on a determination of the existence of at least one of generic equivalents of the selected prescription medication, more preferred status than the selected prescription medication, and class alternatives to the selected prescription medication.

14. The device according to claim 1 further comprising:
a printer to print a multiple-part form including a legal prescription and a chart copy attached to the prescription by a frangible connection.

15. The device according to claim 14 wherein said printer is further configured to print a consumer-oriented message on the form.

16. The device according to claim 15, wherein said multiple-part form includes two frangible connections to create a three-portion form, with said chart copy being on the first portion of said form, said legal prescription being on the second portion of the said form, and said consumer message being on the third portion of the said form.

17. The device according to claim 11 wherein said frangible connection is created by said printer by partially cutting the paper such that the prescription and the chart copy are initially attached with an uncut portion of the paper.

18. The device according to claim 1 wherein said processor is configured to display a patient selection screen showing a list of patients on said display based on information from at least one of a patient database, an Electronic Medical Records (EMR) database, or a physician's office management information system (POMIS) database.

19. The device according to claim 18 wherein said processor is further configured to display a prescription drug history based on at least one of the patient database, the Electronic Medical Records (EMR) database, the physician's office management information system (POMIS) database, or health plan records, in response to selecting one of the patients on the patient selection screen.

20. The device according to claim 1, wherein said processor determines whether any alternative prescription medication exists by querying a database having information specific to the patients' health plan formulary.

21. The device according to claim 20, wherein said processor is configured to display a cart screen including characteristic information for the selected prescription medication only, if no alternative prescription medication having equal or more preferred status exists.

22. A method of electronically prescribing medication to a patient comprising the steps of:
providing to a prescriber prescription medications in response to a request to prescribe medication to a patient;
allowing selection of one of the prescription medications;
in response to the selection of one of the prescription medications, determining in a processor whether alternative prescription medications having equal or more preferred status than the selected prescription medication exist based upon the patient's health plan; and
if any such alternative medication exists, alerting the prescriber of the preferred status of the selected prescription medication and alternative prescription medication.

23. The method according to claim 22 wherein said determining step includes querying a database including the formulary status of available prescription medications and, if no alternative medications exist having equal or more preferred status, further comprising the step of providing to the prescriber information characteristic of the selected prescription medication.

24. The method according to claim 22 wherein said providing step provides a listing of prescription medications without any indication of formulary status.

25. The method according to claim 24 wherein said alerting step is automated and not user selectable.

26. The method according to claim 25, wherein formulary status is only provided as part of said alerting step.

27. The method according to claim 22 wherein said determining step determines whether any alternative prescription medication having a more preferred status than the selected prescription medication exists.

28. The method according to claim 22 wherein said alerting step further comprises the step of alerting the prescriber of the equivalent mapped dosage of any alternative prescription medication having an equal or more preferred status than the selected prescription medication based upon the patient's health plan formulary.

29. The method according to claim 28 wherein said equivalent mapped dosage alerting step comprises alerting the prescriber as to the equivalent mapped dosages of all alternative prescription medications having equal or preferred formulary status than the selected prescription medication.

30. The method according to claim 28 further comprising allowing selection of one of the selected or alternative prescription medications.

31. The method according to claim 30 further comprising the step of displaying a checkout screen to allow selection of a specific drug fulfillment entity to electronically send the prescription or print the prescription on paper.

32. The method according to claim 31, wherein fulfillment cost information of the selected medication is displayed on the checkout screen.

33. The method according to claim 22 further comprising, in response to selecting one of the prescription medications, determining in the processor whether there exists at least one of generic equivalents to the selected prescription medication, more preferred status than the selected prescription medication, and class alternatives to the selected prescription medication.

34. The method according to claim 22 further comprising the step of providing a list of patients based on at least one of a patient database, an Electronic Medical Records (EMR) database, or a physician's office management information system (POMIS) database.

35. The method according to claim 34 further comprising the step of obtaining a prescription drug history based on information from at least one of the patient database, the Electronic Medical Records (EMR) database, the physician's office management information system (POMIS) database, or health plan records in response to selecting one patient in the list of patients.

36. A computer readable medium executable on a computer for prescribing medication with an electronic device having a display, said computer readable medium executing the steps of:
listing prescription medications on an electronic display in response to a request to prescribe medication to a patient;
allowing selection of one of the prescription medications on the display;
in response to the selection of one of the prescription medications, determining in a processor whether alternative prescription medications having equal or more preferred status than the selected prescription medication exist based upon the patient's health plan; and
if any such alternative medication exists, alerting the prescriber of the preferred status of the selected prescription medication and alternative prescription medications.

37. A device for electronically alerting a prescriber as to the existence of low cost alternatives to a prescription drug during electronic prescribing, said device comprising:
means for providing prescription medications in response to a request to prescribe medication to a specific patient;
means for allowing selection of one of the prescription medications; and
means for determining and alerting a prescriber, in response to the selection of one of the prescription medications, the selected prescription medication, together with alternative prescription medications having equal or more preferred status than the selected prescription medication, if any exist, as determined by the patient's health plan.

38. The device of claim 37 further comprising means for providing a relative ranking factor indicative of the preference status of the selected prescription medication and the alternative prescription medications, if any exist.

39. A computer system for electronically alerting a prescriber as to the existence of lower cost alternatives to a prescription drug during electronic prescribing, said computer system comprising:
an electronic data center in communication with at least one drug information database selected from the group consisting of a pharmacy, drug, drug reference, and drug equivalence database;
a source of patient-specific health plan information, including at least one of medication history and pharmacy benefit plan information, and an electronic prescription fulfillment entity in communication with at least one drug fulfillment service;
a point of care computer system including a controller and at least one of a database containing patient-specific information and an electronic prescribing device, said controller being in electronic communication with and managing connectivity between said electronic prescribing device and said electronic data center to upload information from the patient-specific health plan information source to said electronic prescribing device, to upload information from the at least one drug information database to said electronic prescribing device, and to download prescription information from said electronic prescribing device to the electronic prescription fulfillment entity; and
said electronic prescribing device being responsive to selection of a prescription drug for a patient to display cost information related to alternative drugs having a more preferred status based upon the patients' health plan, if any exist, thereby alerting the prescriber to the existence of lower cost alternative drugs than the selected prescription drug.

40. The computer system of claim 39, wherein the source of health plan information comprises an aggregator of prescription benefit information, and the electronic prescription fulfillment entity is in communication with at least one of retail and mail order pharmacies.

41. The computer system of claim 39, wherein said controller permits at least some of the transmissions between the data center and the electronic prescribing device to occur in real time.
